(19) United States
(12) Patent Application Publication
(10) Pub. No.: US 2019/0243373 A1
(43) Pub. Date: Aug. 8, 2019

(54) AUTOMATIC CLEANING DEVICE AND AUTOMATIC CHARGING METHOD

(71) Applicant: IBOT Robotic Co. Ltd., Taipei City (TW)

(72) Inventors: Chia-Jui Kuo, New Taipei City (TW); Hung-Chou Chen, New Taipei City (TW); Chun-Chieh Huang, Taipei City (TW)

(73) Assignee: IBOT Robotic Co. Ltd., Taipei City (TW)

(21) Appl. No.: 15/986,781

(22) Filed: May 22, 2018

(30) Foreign Application Priority Data
Feb. 6, 2018 (TW) 107104101

(51) Int. Cl. G05D 1/02; A47L 9/28; H02J 7/00; B25J 11/00; B25J 9/16; B60L 11/18

(52) U.S. Cl. CPC G05D 1/0225; A47L 9/2852; A47L 9/2873; H02J 7/0042; B25J 11/0085; B25J 9/1666; G05D 2201/0215; G05D 1/0231; B60L 11/1833; A47L 2201/022; Y10S 901/01; Y10S 901/47; Y10S 901/09; B25J 9/1697

(57) ABSTRACT

An automatic cleaning device including a first light sensor and a controller is provided. The first light sensor is disposed at a side position of a device body. The controller is coupled to the first light sensor. When the controller performs an automatic charging operation, the controller controls the device body of the automatic cleaning device to move forward and determines whether the first light sensor senses a light signal emitted by a light emitter of the charging dock. When the first light sensor senses the light signal, the controller records a first time parameter, and when the first light sensor no longer senses the light signal, the controller records a second time parameter. The controller determines whether to execute a first return mode or a second return mode according to a first time difference between the first time parameter and the second time parameter. In addition, an automatic charging method is also provided.

### CROSS-REFERENCE TO RELATED APPLICATION

This application claims the priority benefit of Taiwan application serial no. 107104101, filed on Feb. 6, 2018. The entirety of the above-mentioned patent application is hereby incorporated by reference herein and made a part of this specification.

### BACKGROUND

### Field of the Invention

The invention relates to a charging technique and more particularly, to an automatic cleaning device and an automatic charging method thereof.

### Description of Related Art

In the technical field of cleaning robot, there are more and more researches and designs regarding how to design a cleaning robot with an automatic charging function so as to improve the performance in using the cleaning robot. However, if the cleaning robot cannot make its machine body return to the position of a charging dock via an effective moving path, it may influence whether the cleaning robot is capable of operating for a long term, and may even result in cleaning effect drops. Accordingly, regarding how to design the cleaning robot to accurately move toward the charging dock for ensuring a power receiving portion of the cleaning robot to be electrically connected to a power supply portion of the charging station for effectively charging the cleaning robot, the invention provides solution of several embodiments as follows.

### SUMMARY

The invention provides an automatic cleaning device and an automatic charging method thereof capable of accurately determining a position of a charging dock, such that a device body of the automatic cleaning device can be automatically combined with the charging dock to charge the automatic cleaning device by the charging dock.

An automatic cleaning device of the invention includes a device body. The device body is adapted to be selectively combined with a charging dock, so as to charge the automatic cleaning device by the charging dock. The automatic cleaning device includes a first light sensor and a controller. The first light sensor is disposed at a side position of the device body. The controller is coupled to the first light sensor. When the controller performs an automatic charging operation, the controller controls the device body to move forward and determines whether the first light sensor senses a light signal emitted by a light emitter of the charging dock. When the first light sensor senses the light signal, the controller records a first time parameter, and when the first light sensor no longer senses the light signal, the controller records a second time parameter. The controller determines whether to execute a first return mode or a second return mode according to a first time difference between the first time parameter and the second time parameter.

An automatic charging method of the invention is applicable to an automatic cleaning device. A device body of the automatic cleaning device is adapted to be selectively combined with a charging dock, so as to charge the automatic cleaning device by the charging dock. The automatic cleaning device includes a first light sensor and a controller. The first light sensor is disposed at a side position of the device body. The automatic charging method includes the following steps. The device body is controlled to move forward, and whether the first light sensor senses a light signal emitted by a light emitter of the charging dock is determined. When the first light sensor senses the light signal, a first time parameter is recorded, and when the first light sensor no longer senses the light signal, a second time parameter is recorded. Whether to execute a first return mode or a second return mode is determined according to a first time difference between the first time parameter and the second time parameter.

To sum up, the automatic cleaning device and the automatic charging method of the invention can effectively determine a size of a light emitting angle of the light signal emitted by the light emitter of the charging dock, such that the automatic cleaning device can correspondingly select the adaptive return mode according to the size of the light emitting angle, thereby automatically moving to the charging dock. Therefore, the device body of the automatic cleaning device can be effectively and accurately combined with the charging dock.

In order to make the aforementioned and other features and advantages of the invention more comprehensible, several embodiments accompanied with figures are described in detail below.

### BRIEF DESCRIPTION OF THE DRAWINGS

The drawings illustrate embodiments of the invention and, together with the description, serve to explain the principles of the invention.

FIG. 1 is a schematic view illustrating an automatic cleaning device and a charging dock according to an embodiment of the invention.

FIG. 2A is a side view illustrating the automatic cleaning device according to an embodiment of the invention.

FIG. 2B is a rear view illustrating the automatic cleaning device according to an embodiment of the invention.

FIG. 3 is a front view illustrating the charging dock according to an embodiment of the invention.

FIG. 4 is a flow chart illustrating an automatic charging method according to an embodiment of the present invention.

FIG. 5 is a schematic view illustrating an automatic cleaning device obtaining a first time parameter and a second time parameter according to an embodiment of the invention.

FIG. 6 is a flow chart illustrating a first return mode according to an embodiment of the present invention.

FIG. 7A, FIG. 7B and FIG. 7C are schematic views illustrating an automatic cleaning device performing a first return mode according to an embodiment of the invention.

FIG. 8 is a flow chart illustrating a second return mode according to an embodiment of the present invention.

FIG. 9A, FIG. 9B and FIG. 9C are schematic views illustrating an automatic cleaning device performing a second return mode according to an embodiment of the invention.

### DESCRIPTION OF EMBODIMENTS

In order to make the content of the invention to be more comprehensive, a plurality of embodiments are provided below for describing the invention; however the invention is not limited to the illustrated embodiments. Moreover, the illustrated exemplary embodiments may also be suitably combined. Moreover, wherever possible, elements/components/steps with same reference numerals represent same or similar parts in the drawings and embodiments.

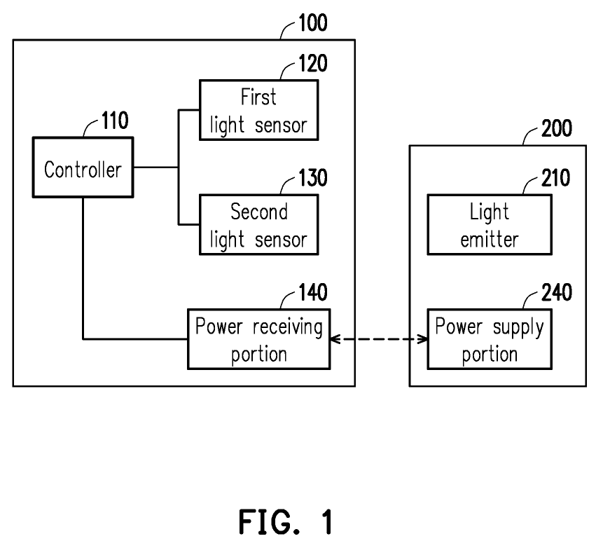

FIG. 1 is a schematic view illustrating an automatic cleaning device and a charging dock according to an embodiment of the invention. Referring to FIG. 1, an automatic cleaning device 100 includes a controller 110, a first light sensor 120, a second light sensor 130 and a power receiving portion 140. The controller 110 is coupled to the first light sensor 120, the second light sensor 130 and the power receiving portion 140. A charging dock 200 includes a light emitter 210 and a power supply portion 240. In the present embodiment, the automatic cleaning device 100 is an auto clean robot with an automatic charge function. In the present embodiment, a device body of the automatic cleaning device 100 is adapted to be selectively combined with the charging dock 200, such that the charging dock 200 charges the automatic cleaning device 100. When the device body of the automatic cleaning device 100 is combined with the charging dock 200, the power receiving portion 140 of the automatic cleaning device 100 is electrically connected to the power supply portion 240 of the charging dock 200, such that the power receiving portion 140 receives charging electricity provided by the power supply portion 240.

In the present embodiment, the controller 110 may be a central processing unit (CPU) or any other general or specific purpose programmable microprocessor, a digital signal processor (DSP), a programmable controller, an application specific integrated circuit (ASIC), a programmable logic device (PLD) or other similar devices, or a combination of these devices. In the present embodiment, the controller 110 is capable of computing and recording parameters, thereby achieving parameter computation and parameter recording functions described in each of the embodiments of the invention. Meanwhile, the controller 110 is capable of outputting a control signal. The controller 110 may output the control signal to a driving element of the automatic cleaning device 100 to control the device body of the automatic cleaning device 100, thereby achieving the moving operation described in each of the embodiments of the invention.

In the present embodiment, the first light sensor 120 and the second light sensor 130 may be, for example, infrared sensors, and the light emitter 210 may be, for example, an infrared emitter, but the invention is not limited thereto. In the present embodiment, the light emitter 210 is configured to emit a light signal, such that when the automatic cleaning device 100 performs an automatic charging operation, the automatic cleaning device 100 may sense the light signal emitted by the light emitter 210 by the first light sensor 120 and the second light sensor 130. Thus, the automatic cleaning device 100 may effectively determine a position of the charging dock 200.

In the present embodiment, the automatic cleaning device 100 may further include a battery module. The power supply portion 240 of the charging dock 200 may be coupled to a city power supply providing an alternating current (AC) power and coverts the AC power of the city power supply into a direct current (DC) power. When the automatic cleaning device 100 is docked at the charging dock 200, the power supply portion 240 may be electrically connected to the power receiving portion 140 of the automatic cleaning device 100 and supply the DC power to the automatic cleaning device 100, such that the automatic cleaning device 100 performs a charging operation on the battery module. In the present embodiment, the power supply portion 240 may have two electrode sheets made of a metal material and serving the two electrode sheets as a positive electrode and a negative electrode.

In the present embodiment, the automatic cleaning device 100 may further include a cleaning module and a power module. When the automatic cleaning device 100 enters an automatic cleaning mode, the automatic cleaning device 100 may walk on the floor with the power module and perform a floor cleaning task with the cleaning module. For example, the power module may include a motor and wheels. The power module may provide the power to drive the wheels with the battery module, thereby driving the automatic cleaning device 100 to walk on the floor. Meanwhile, the power module may also drive the cleaning module, thereby driving cleaning tools of the cleaning module to perform cleaning operations of rotating, swinging and so on. However, sufficient teaching, suggestion and implementation description related to detailed technical features of the cleaning module and the power module of the present embodiment may be obtained based on common knowledge of this field and thus, will not be repeated.

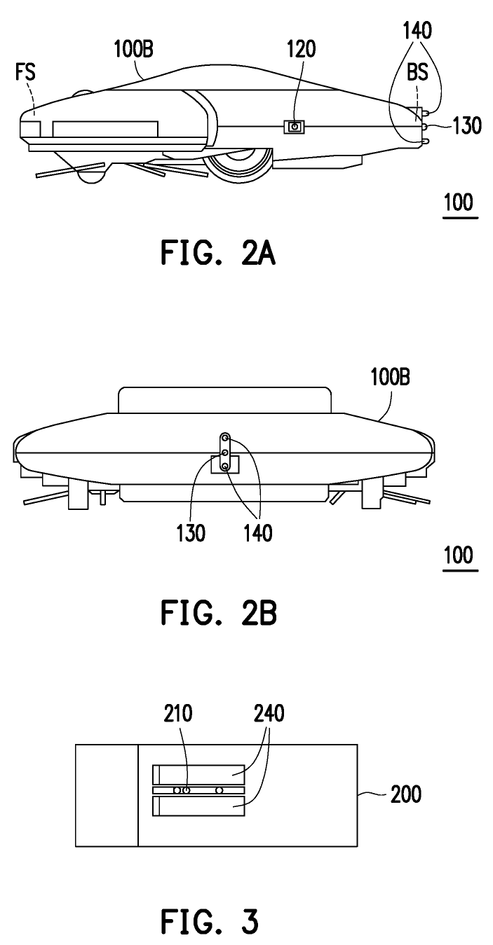

FIG. 2A is a side view illustrating the automatic cleaning device according to an embodiment of the invention. FIG. 2B is a rear view illustrating the automatic cleaning device according to an embodiment of the invention. Referring to FIG. 1 to FIG. 2B, a device body 100B of the automatic cleaning device 100 is as illustrated in FIG. 2A. In the present embodiment, the first light sensor 120 is disposed at a side position of the device body 100B, the second light sensor 130 is disposed at a back side position of a device body 100B. The first light sensor 120 and the second light sensor 130 has a same horizontal height. In the present embodiment, the power receiving portion 140 has two electrode sheets, and the power receiving portion 140 is disposed at the back side position, wherein the second light sensor 130 is disposed in the power receiving portion 140. In the present embodiment, an included angle is formed between a connection line from a center position of the device body 100B to the first light sensor 120 and another connection line from the center position to the second light sensor 130, wherein the included angle is, for example, 90°. It should be noted that the aforementioned center position refers to the center of the device body 100B which is on a same horizontal plane with the first light sensor 120 and the second light sensor 130. Additionally, a front side FS and a back side BS of the automatic cleaning device 100 described in each of the embodiments of the invention may be, for example, positions of the device body 100B illustrated in 2A.

FIG. 3 is a front view illustrating the charging dock according to an embodiment of the invention. Referring to FIG. 1 to FIG. 3, the charging dock 200 is as illustrated in FIG. 3, for example. In the present embodiment, the power supply portion 240 of the charging dock 200 has two electrode sheets disposed on the top and the bottom, and the light emitter 210 is located in the power supply portion 240. In the present embodiment, the charging dock 200 is, for example, fixedly disposed on a wall surface, and the light emitter 210, the first light sensor 120 and the second light sensor 130 has the same horizontal height. In the present embodiment, the power supply portion 240 of the charging dock 200 is adapted to be combined with the power receiving portion 140 of the automatic cleaning device 100, such that the power supply portion 240 charges the power receiving portion 140.

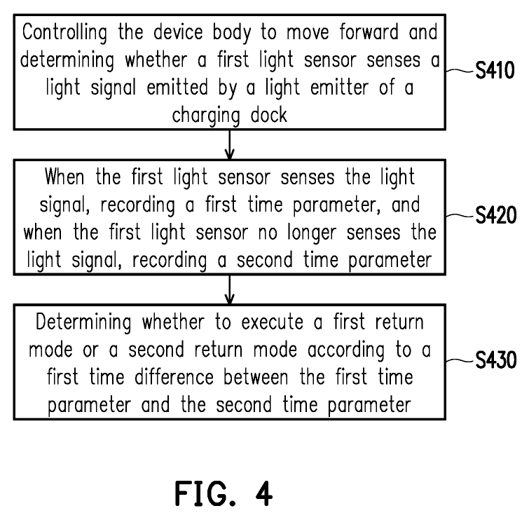

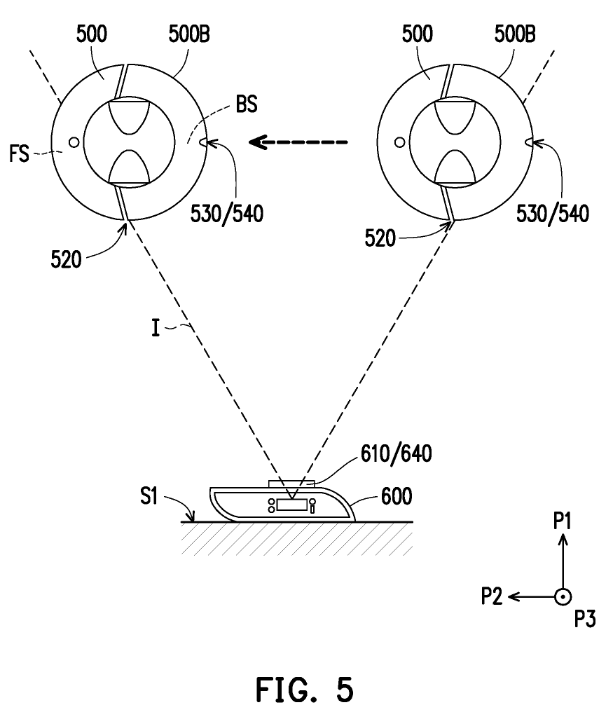

FIG. 4 is a flow chart illustrating an automatic charging method according to an embodiment of the present invention. FIG. 5 is a schematic view illustrating an automatic cleaning device obtaining a first time parameter and a second time parameter according to an embodiment of the invention. Referring to FIG. 4 and FIG. 5, the automatic charging method of the present embodiment may be at least applied to the automatic cleaning device illustrated in FIG. 5. In the present embodiment, when an automatic cleaning device 500 performs an automatic charging operation, a controller of the automatic cleaning device 500 may, for example, control a device body 500B to move in a random direction, such that the device body 500B may get close to a wall surface S1. Meanwhile, after the device body 500B faces the wall surface S1, the automatic cleaning device 500 may control the device body 500B to subsequently move in a direction P2 and walk along the wall with a preset distance from the wall surface S1.

In the present embodiment, the device body 500B of the automatic cleaning device 500 walking along the wall means that the automatic cleaning device 500 may walk near the wall surface S1, wherein a manner of the device body 500B of the automatic cleaning device 500 walking along the wall surface S1 may be a straight walking manner in parallel to the wall surface S1, or a serrate walking manner not in parallel to the wall surface S1, which is not limited in the invention. Sufficient teaching, suggestion and implementation description related to the walking manner and the path of the automatic cleaning device 500 of the present embodiment may be obtained based on common knowledge of this field and thus, will not be repeated. Additionally, a front side FS and a back side BS of the automatic cleaning device 500 described in each of the embodiments of the invention may be, for example, positions of the device body 500B illustrated in FIG. 5.

In the present embodiment, when the device body 500B walks along the wall surface S1, the automatic cleaning device 500 may perform the following steps. In step S410, the automatic cleaning device 500 controls the device body 500B to move forward and determines whether a first light sensor 520 senses a light signal I emitted by a light emitter 610 of a charging dock 600. In step S420, when the first light sensor 520 senses the light signal I, the automatic cleaning device 500 records a first time parameter, and when the first light sensor 520 no longer senses the light signal I, the controller records a second time parameter. In the present embodiment, when the first light sensor 520 no longer senses the light signal I, the automatic cleaning device 500 controls the device body 500B to stop moving forward and waits for the controller to determine whether to execute a first return mode and a second return mode and then performs a corresponding movement. In step S430, the automatic cleaning device 500 determines whether to execute the first return mode or the second return mode according to a time length of a first time difference between the first time parameter and the second time parameter.

In other words, in the present embodiment, as a light-emitting angle of the light signal I varies with a specification or a model of the light emitter 610, the automatic cleaning device 500 of the present embodiment may effectively determine a size of the light-emitting angle of the light signal I emitted by the light emitter 610 by means of calculating the time difference, thereby executing the corresponding return mode. Additionally, sufficient teaching, suggestion and implementation related to device features, implementation manner and technical details with respect to the automatic cleaning device 500 of the present embodiment may refer to the contents related to the embodiments illustrated in FIG. 1 to FIG. 3 and thus, will not be repeated.

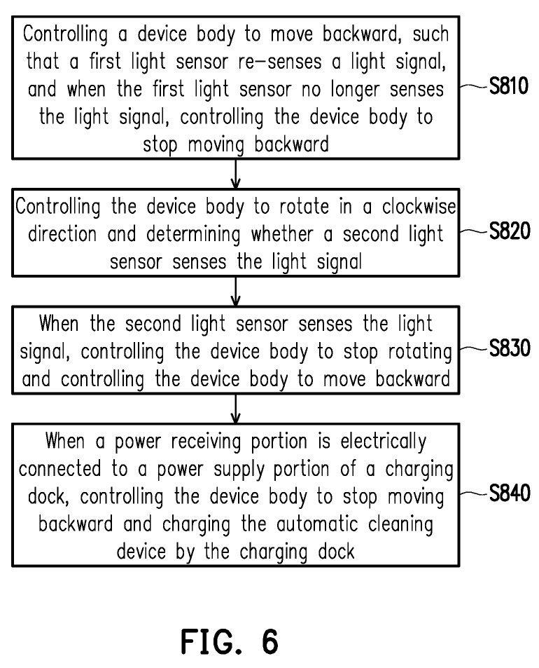

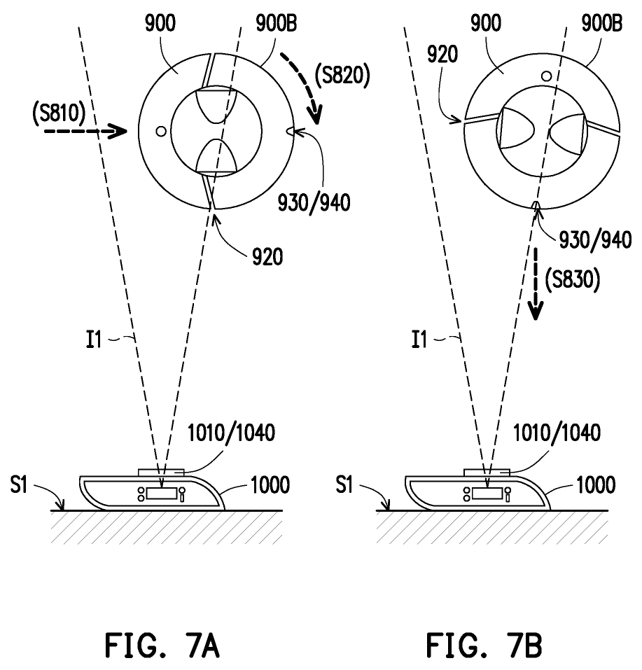

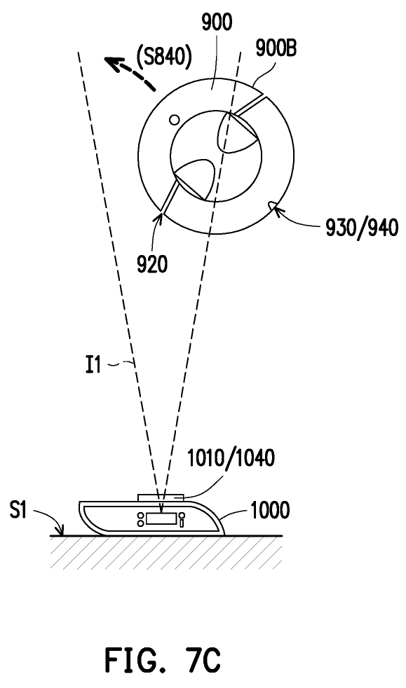

FIG. 6 is a flow chart illustrating a first return mode according to an embodiment of the present invention. FIG. 7A, FIG. 7B and FIG. 7C are schematic views illustrating an automatic cleaning device 900 performing a first return mode according to an embodiment of the invention. Referring to FIG. 6 to FIG. 7C, the automatic charging method of the present embodiment may be at least applied to an automatic cleaning device 900 illustrated in FIG. 7A, FIG. 7B and FIG. 7C. After the automatic cleaning device 900 obtains a first time parameter and a second time parameter, if the automatic cleaning device 900 determines that the first time difference is less than a threshold (e.g., 1 second), the automatic cleaning device 900 determines to execute the first return mode. In the present embodiment, the first return mode is applicable to a narrower light-emitting angle.

In the present embodiment, when the automatic cleaning device 900 executes the first return mode, the automatic cleaning device 900 may perform the following steps. In step S810, the automatic cleaning device 900 controls a device body 900B to move backward, such that a first light sensor 920 re-senses a light signal I1, and when the first light sensor 920 no longer senses the light signal I1, the automatic cleaning device 900 controls the device body 900B to stop moving backward. In step S820, the automatic cleaning device 900 controls the device body 900B to rotate in a clockwise direction and determines whether a second light sensor 930 senses the light signal I1. In step S830, when the second light sensor 930 senses the light signal I1, the automatic cleaning device 900 controls the device body 900B to stop rotating, and a controller controls the device body 900B to move backward. In step S840, when a power receiving portion 940 is electrically connected to a power supply portion 1040 of a charging dock 1000, the automatic cleaning device 900 controls the device body 900B to stop moving backward, and the charging dock 1000 charges the automatic cleaning device 900. Thus, in a scenario that a light emitter 1010 of the charging dock 1000 has a narrower light-emitting angle, the automatic cleaning device 900 of the present embodiment may effectively return to the charging dock 1000, such that the power receiving portion 940 of the automatic cleaning device 900 may be accurately electrically connected to the power supply portion 1040 of the charging dock 1000.

However, in step S830, during the process of the device body 900B moving backward, if the second light sensor 930 no longer senses the light signal I1, the automatic cleaning device 900 controls the device body 900B to stop moving backward. Then, the automatic cleaning device 900 controls the device body 900B to move in a counterclockwise arc direction, such that a center position of the device body 900B may move into a signal range of the light signal I1. Thereafter, when the second light sensor 930 again senses the light signal I1, the automatic cleaning device 900 controls the device body 900B to stop moving and controls the device body 900B to continue to move backward, such that the device body 900B moves toward the charging dock 1000. In another embodiment, when the device body 900B moves in the counterclockwise arc direction beyond a preset angle range (e.g., 90°), or the second light sensor 930 has not sensed the light signal I1 after a preset time period is passed, the automatic cleaning device 900 controls the device body 900B to stop moving in the counterclockwise arc direction and re-performs step S820. Thus, during the process of the device body 900B moving backward, if a direction in which the device body 900B moves backward has a deviation, the automatic cleaning device 900 of the present embodiment is capable of effectively adjusting the direction in which the device body 900B moves backward, so as to effectively return to the charging dock 1000.

Additionally, sufficient teaching, suggestion and implementation related to device features, implementation manner and technical details with respect to the automatic cleaning device 900 of the present embodiment may refer to the contents related to the embodiments illustrated in FIG. 1 to FIG. 5 and thus, will not be repeated.

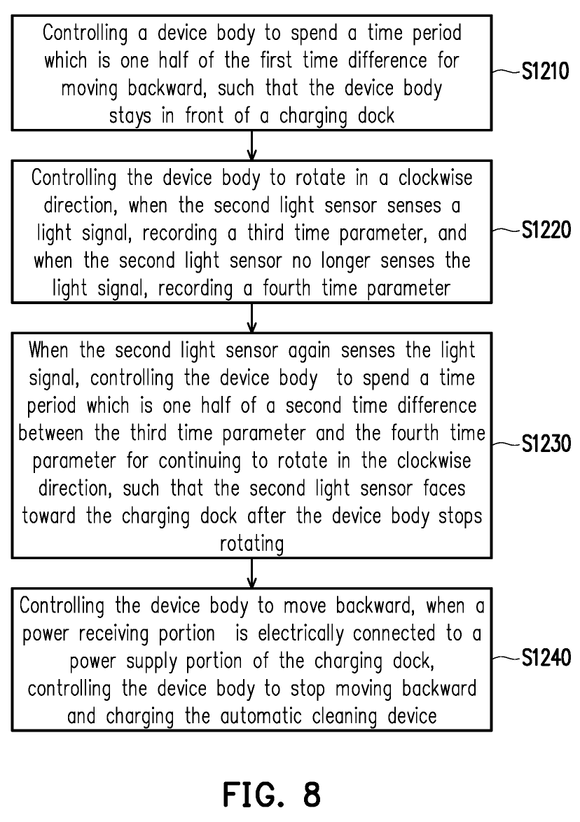

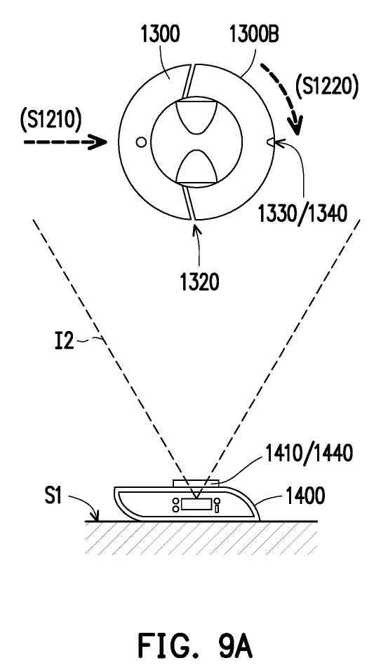

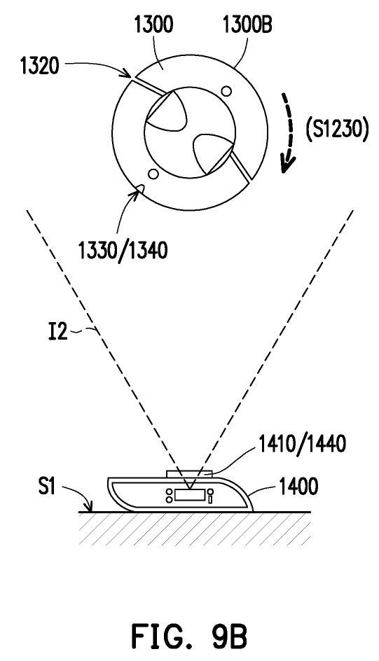

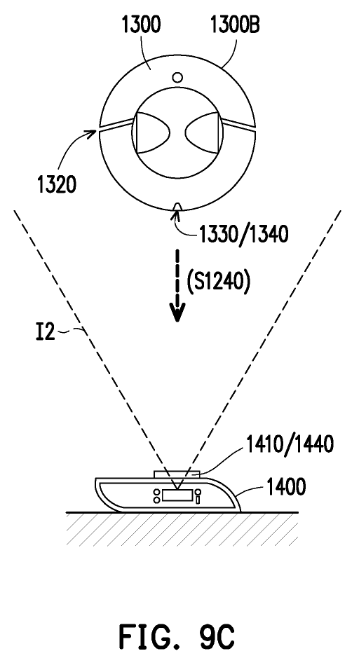

FIG. 8 is a flow chart illustrating a second return mode according to an embodiment of the present invention. FIG. 9A, FIG. 9B and FIG. 9C are schematic views illustrating an automatic cleaning device performing a second return mode according to an embodiment of the invention. Referring to FIG. 8 to FIG. 9C, the automatic charging method of the present embodiment may be at least applied to an automatic cleaning device 1300 illustrated in FIG. 9A, FIG. 9B and FIG. 9C. After the automatic cleaning device 1300 obtains a first time parameter and a second time parameter, if the automatic cleaning device 1300 determines that the first time difference is greater than a threshold, the automatic cleaning device 1300 determines to execute the second return mode. In the present embodiment, the second return mode is applicable to a wider light-emitting angle.

In the present embodiment, when the automatic cleaning device 1300 executes the second return mode, the automatic cleaning device 1300 may perform the following steps. In step S1210, the automatic cleaning device 1300 controls a device body 1300B to spend a time period which is one half of the first time difference for moving backward, such that the device body 1300B may stay in front of a charging dock 1400. In step S1220, the automatic cleaning device 1300 controls the device body 1300B to rotate in a clockwise direction, when the second light sensor 1330 senses a light signal 12, the automatic cleaning device 1300 records a third time parameter, and when the second light sensor 1330 no longer senses the light signal 12, the automatic cleaning device 1300 records a fourth time parameter. In step S1230, when the second light sensor 1330 again senses the light signal 12, the automatic cleaning device 1300 controls the device body 1300B to spend a time period which is one half of a second time difference between the third time parameter and the fourth time parameter for continuing to rotate in the clockwise direction, such that the second light sensor 1330 faces toward the charging dock 1400 after the device body 1300B stops rotating. In step S1240, the automatic cleaning device 1300 controls the device body 1300B to move backward, when a power receiving portion 1340 is electrically connected to a power supply portion 1440 of the charging dock 1400, the automatic cleaning device 1300 controls the device body 1300B to stop moving backward, and the charging dock 1400 charges the automatic cleaning device 1300. Thus, in a scenario that a light emitter 1410 of the charging dock 1400 has a wider light-emitting angle, the automatic cleaning device 1300 of the present embodiment is capable of effectively returning to the charging dock 1400, such that the power receiving portion 1340 of the automatic cleaning device 1300 may be accurately electrically connected to the power supply portion 1440 of the charging dock 1400.

However, in step S1240, during the process of the device body 1300B moving backward, if the second light sensor 1330 no longer senses the light signal 12, the automatic cleaning device 1300 controls the device body 1300B to stop moving backward. Then, the automatic cleaning device 1300 controls the device body 1300B to rotate in a clockwise direction, when the second light sensor 1330 senses the light signal 12, the automatic cleaning device 1300 records a fifth time parameter, and when the second light sensor 1330 no longer senses the light signal 12, the automatic cleaning device 1300 records a sixth time parameter. Thereafter, when the second light sensor 1330 again senses the light signal 12, the automatic cleaning device 1300 controls the device body 1300B to spend a time period which is one half of a third time difference between the fifth time parameter and the sixth time parameter for continuing to rotate in the clockwise direction, such that the second light sensor 1330 faces toward the charging dock 1400 after the device body 1300B stops rotating. Finally, the automatic cleaning device 1300 controls the device body 1300B to continue to move backward. Thus, during the process of the device body 1300B moving backward, if a direction in which the device body 1300B moves backward has a deviation, the automatic cleaning device 1300 of the present embodiment may effectively adjust the direction in which the device body 1300B moves backward, so as to effectively return to the charging dock 1400.

Additionally, sufficient teaching, suggestion and implementation related to device features, implementation manner and technical details with respect to the automatic cleaning device 1300 of the present embodiment may refer to the contents related to the embodiments illustrated in FIG. 1 to FIG. 7 and thus, will not be repeated.

Based on the above, the automatic cleaning device and the automatic charging method of the invention can correspondingly select the adaptive return mode by determining the time length in which the device body moves within the light signal range, such that the automatic cleaning device of the invention can be adapted to be combined with various types of charging docks having the light emitters w various light emission angles.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An automatic cleaning device, having a device body adapted to be selectively combined with a charging dock to charge the automatic cleaning device by the charging dock, the automatic cleaning device comprising:
a first light sensor, disposed at a side position of the device body; and
a controller, coupled to the first light sensor, wherein when the controller performs an automatic charging operation, the controller controls the device body to move forward and determines whether the first light sensor senses a light signal emitted by a light emitter of the charging dock,
wherein when the first light sensor senses the light signal, the controller records a first time parameter, and when the first light sensor no longer senses the light signal, the controller records a second time parameter,
wherein the controller determines whether to execute a first return mode or a second return mode according to a first time difference between the first time parameter and the second time parameter.

2. The automatic cleaning device according to claim 1, wherein a power receiving portion of the device body has two electrode sheets disposed on the top and the bottom, and a power supply portion of the charging dock has another two electrode sheets disposed on the top and the bottom, wherein the power receiving portion is adapted to be selectively combined with the power supply portion, so as to charge the power receiving portion by the power supply portion.

3. The automatic cleaning device according to claim 2, wherein the light emitter of the charging dock is located in the power supply portion, and the light emitter and the first light sensor have a same horizontal height.

4. The automatic cleaning device according to claim 1, wherein when the first light sensor no longer senses the light signal, the controller controls the device body to stop moving forward and determines whether the first time difference is greater than a threshold, so as to determine to execute the first return mode or the second return mode.

5. The automatic cleaning device according to claim 1, further comprising:
a second light sensor, coupled to the controller and disposed at a back side position of the device body, wherein an included angle is formed between a connection line from a center position of the device body to the first light sensor and another connection line from the center position to the second light sensor; and
a power receiving portion, coupled to the controller and disposed at the back side position of the device body.

6. The automatic cleaning device according to claim 5, wherein if the controller determines that the first time difference is not greater than the threshold, the controller executes the first return mode, and the first return mode comprises steps of:
controlling the device body to move forward, such that the first light sensor re-senses the light signal, and when the first light sensor no longer senses the light signal, controlling the device body to stop moving forward;
controlling the device body to rotate in a clockwise direction and determining whether the second light sensor senses the light signal;
when the second light sensor senses the light signal, controlling the device body to stop rotating and controlling the device body to move backward; and
when the power receiving portion is electrically connected to a power supply portion of the charging dock, controlling the device body to stop moving backward and charging the automatic cleaning device by the charging dock.

7. The automatic cleaning device according to claim 6, wherein the step of controlling the device body to move forward comprises:
when the second light sensor no longer senses the light signal, controlling the device body to stop moving backward;
controlling the device body to move in a counterclockwise arc direction, and when the second light sensor again senses the light signal, controlling the device body to stop moving; and
controlling the device body to continue to move backward.

8. The automatic cleaning device according to claim 7, wherein the step of controlling the device body to move in the counterclockwise arc direction comprises:
when the device body moves in the counterclockwise arc direction beyond a preset angle range, and the second light sensor still does not sense the light signal, controlling the device body to stop moving in the counterclockwise arc direction; and
re-controlling the device body to rotate in the clockwise direction and determining whether the second light sensor senses the light signal.

9. The automatic cleaning device according to claim 5, wherein if the controller determines that the first time difference is greater than the threshold, the controller executes the second return mode, and the second return mode comprises steps of:
controlling the device body to spend a time period which is one half of the first time difference for moving backward, such that the device body stays in front of the charging dock;
controlling the device body to rotate in a clockwise direction, when the second light sensor senses the light signal, recording a third time parameter, and when the second light sensor no longer senses the light signal, recording a fourth time parameter;
when the second light sensor again senses the light signal, controlling the device body to spend a time period which is one half of a second time difference between the third time parameter and the fourth time parameter for continuing to rotate in the clockwise direction, such that the second light sensor faces toward the charging dock after the device body stops rotating; and
controlling the device body to move backward, when the power receiving portion is electrically connected to a power supply portion of the charging dock, controlling the device body to stop moving backward and charging the automatic cleaning device by the charging dock.

10. The automatic cleaning device according to claim 9, wherein the step of controlling the device body to move backward comprises:
when the second light sensor no longer senses the light signal, controlling the device body to stop moving backward;
controlling the device body to rotate in the clockwise direction, when the second light sensor senses the light signal, recording a fifth time parameter, and when the second light sensor no longer senses the light signal, recording a sixth time parameter;
when the second light sensor again senses the light signal, controlling the device body to spend a time period which is one half of a third time difference between the fifth time parameter and the sixth time parameter for continuing to rotate in the clockwise direction, such that the second light sensor faces toward the charging dock after the device body stops rotating; and
controlling the device body to continue to move backward.

11. An automatic charging method, applicable to an automatic cleaning device, wherein a device body of the automatic cleaning device is adapted to be selectively combined with a charging dock to charge the automatic cleaning device by the charging dock, the automatic cleaning device comprises a first light sensor and a controller, and the first light sensor is disposed at a side position of the device body, the automatic charging method comprising:
controlling the device body to move forward and determining whether the first light sensor senses a light signal emitted by a light emitter of the charging dock;
when the first light sensor senses the light signal, recording a first time parameter, and when the first light sensor no longer senses the light signal, recording a second time parameter; and
determining whether to execute a first return mode or a second return mode according to a first time difference between the first time parameter and the second time parameter.

12. The automatic charging method according to claim 11, wherein a power receiving portion of the device body has two electrode sheets disposed on the top and the bottom, and a power supply portion of the charging dock has another two electrode sheets disposed on the top and the bottom, wherein the power receiving portion is adapted to be selectively combined with the power supply portion, so as to charge the power receiving portion by the power supply portion.

13. The automatic charging method according to claim 12, wherein the light emitter of the charging dock is located in the power supply portion, and the light emitter and the first light sensor have a same horizontal height.

14. The automatic charging method according to claim 11, wherein the step of determining whether to execute the first return mode or the second return mode according to the first time difference between the first time parameter and the second time parameter comprises:
controlling the device body to stop moving forward and determining whether the first time difference is greater than a threshold, so as to determine to execute the first return mode or the second return mode.

15. The automatic charging method according to claim 11, wherein the automatic cleaning device further comprises a second light sensor and a power receiving portion, and the second light sensor and the power receiving portion are disposed at a back side position of the device body, wherein an included angle is formed between a connection line from a center position of the device body to the first light sensor and another connection line from the center position to the second light sensor.

16. The automatic charging method according to claim 15, wherein if the first time difference is not greater than the threshold, executing the first return mode, and the first return mode comprising:
controlling the device body to move backward, such that the first light sensor re-senses the light signal, and when the first light sensor no longer senses the light signal, controlling the device body to stop moving backward;
controlling the device body to rotate in a clockwise direction and determining whether the second light sensor senses the light signal;
when the second light sensor senses the light signal, controlling the device body to stop rotating and controlling the device body to move backward; and
when the power receiving portion is electrically connected to a power supply portion of the charging dock, controlling the device body to stop moving backward and charging the automatic cleaning device by the charging dock.

17. The automatic charging method according to claim 16, wherein the step of controlling the device body to move backward comprises:
when the second light sensor no longer senses the light signal, controlling the device body to stop moving backward;
controlling the device body to move in a counterclockwise arc direction, and when the second light sensor again senses the light signal, controlling the device body to stop moving; and
controlling the device body to continue to move backward.

18. The automatic charging method according to claim 17, wherein the step of controlling the device body to move in the counterclockwise arc direction comprises:
when the device body moves in the counterclockwise arc direction beyond a preset angle range, and the second light sensor still does not sense the light signal, controlling the device body to stop moving in the counterclockwise arc direction; and
re-controlling the device body to rotate in the clockwise direction and determining whether the second light sensor senses the light signal.

19. The automatic charging method according to claim 15, wherein if the first time difference is greater than the threshold, executing the second return mode, and the second return mode comprising:
controlling the device body to spend a time period which is one half of the first time difference for moving backward, such that the device body stays in front of the charging dock;
controlling the device body to rotate in a clockwise direction, when the second light sensor senses the light signal, recording a third time parameter, and when the second light sensor no longer senses the light signal, recording a fourth time parameter;
when the second light sensor again senses the light signal, controlling the device body to spend a time period which is one half of a second time difference between the third time parameter and the fourth time parameter for continuing to rotate in the clockwise direction, such that the second light sensor faces toward the charging dock after the device body stops rotating; and
controlling the device body to move backward, when the power receiving portion is electrically connected to a power supply portion of the charging dock, controlling the device body to stop moving backward and charging the automatic cleaning device by the charging dock.

20. The automatic charging method according to claim 19, wherein the step of controlling the device body to move backward comprises:
when the second light sensor no longer senses the light signal, controlling the device body to stop moving backward;
controlling the device body to rotate in the clockwise direction, when the second light sensor senses the light signal, recording a fifth time parameter, and when the second light sensor no longer senses the light signal, recording a sixth time parameter;
when the second light sensor again senses the light signal, controlling the device body to spend a time period which is one half of a third time difference between the fifth time parameter and the sixth time parameter for continuing to rotate in the clockwise direction, such that the second light sensor faces toward the charging dock after the device body stops rotating; and
controlling the device body to continue to move backward.
